(19) United States
(12) Patent Application Publication
(10) Pub. No.: US 2013/0112418 A1
(43) Pub. Date: May 9, 2013

(54) Composition and Methods for Protecting Metal Surfaces from Corrosion

(71) Applicants: Ramesh Varadaraj, Flemington, NJ (US); Sabine C. Zeilinger, Spring, TX (US); Catalin Dragos Ivan, Houston, TX (US)

(72) Inventors: Ramesh Varadaraj, Flemington, NJ (US); Sabine C. Zeilinger, Spring, TX (US); Catalin Dragos Ivan, Houston, TX (US)

(21) Appl. No.: 13/701,799

(22) PCT Filed: May 9, 2011
(86) PCT No.: PCT/US11/35717

§ 371 Date: Dec. 3, 2012

Related U.S. Application Data
(60) Provisional application No. 61/368,982, filed on Jul. 29, 2010.

(51) Int. Cl. C09K 8/54; E21B 41/02

(52) U.S. Cl. CPC C09K 8/54; E21B 41/02
USPC 166/305.1; 507/239

(57) ABSTRACT

Guard bed compositions for protecting metal surfaces in a wellbore from corrosion may comprise a variety of constituent components. Exemplary guard bed compositions may include: one or more surfactants selected from the group comprising amine surfactants; one or more co-surfactants selected from the group comprising C3 to C15 alcohols; and one or more non-surfactant amines. Other exemplary guard bed compositions may comprise: a hydrocarbon fluid and an overbased detergent. Still other exemplary guard bed compositions may comprise: a hydrocarbon fluid; one or more surfactants; one or more co-surfactants; and one or more non-surfactant amines. The one or more surfactants may be selected from the group comprising alkyl alkoxylated surfactants. Still further, exemplary guard bed compositions may comprise: a hydrocarbon fluid and one or more associating surface active polymers selected from the group comprising amphiphilic polymers.

This application claims the benefit of U.S. Provisional Patent Application 61/368,982, filed Jul. 29, 2010 entitled COMPOSITIONS AND METHODS FOR PROTECTING METAL SURFACES FROM CORROSION, the entirety of which is incorporated by reference herein.

### FIELD OF THE INVENTION

The present disclosure relates generally to compositions and methods for protecting metal surfaces in a wellbore. More particularly, the present disclosure relates to compositions and methods for protecting metal surfaces from the corrosive effects of prolonged contact with at least one of water and hydrogen sulfide.

### BACKGROUND

This section is intended to introduce the reader to various aspects of art, which may be associated with embodiments of the present invention. This discussion is believed to be helpful in providing the reader with information to facilitate a better understanding of particular techniques of the present invention. Accordingly, it should be understood that these statements are to be read in this light, and not necessarily as admissions of prior art.

As is well understood, hydrocarbon resources have been utilized for many years for a diversity of purposes. In recent years, those seeking to recover and use hydrocarbon resources have turned to more challenging reserves to meet the continuing and increasing demand. For example, many hydrocarbon reserves are in regions in which operations are complicated by political, environmental, or geological issues, rendering wells into those reserves more costly and complicated to drill, complete, and operate. A wide variety of geological issues can affect the complexity and cost of hydrocarbon recovery operations, to the point of making production from some reserves uneconomical. One example of a geological condition that can limit the viability of a proposed hydrocarbon recovery operation is the composition of the material to be produced. For example, subsurface reservoirs may comprise a wide variety of components in a diversity of states. For example, hydrocarbons may be present as liquids, gases, and/or solids. Similarly, other liquids, gases, and solids may be present in the subsurface reservoir or may otherwise be produced through the production wells.

For the purpose of the present background discussion, the term “hydrocarbon components” refers to the various forms in which hydrocarbons may be present. “Diluent components” refers to the various components that reduce the concentration of hydrocarbon components in the produced fluids. For example, diluent components may include water, carbon dioxide, hydrogen sulfide, helium, sand, and other common components. In different ways, each of these diluents can reduce the economy of a proposed hydrocarbon recovery operation. Technologies are continually advancing for addressing the various challenges or complications presented by each of these diluent compositions.

One exemplary limitation in hydrocarbon recovery operations is the interaction between the formation, including the produced fluids, and the completion equipment and/or the production equipment. As is well understood, wells associated with hydrocarbon recovery operations are exceedingly costly to construct (e.g., drill and complete). The equipment installed in a well, such as the completion equipment, is optimally able to withstand the operating conditions of the well for an extended time to maximize the recovery on the capital invested to construct the well. While material properties are continually advancing, the harsh conditions of downhole operations make material selection difficult and costly.

One exemplary challenge presented by the interaction between formation fluids and the completion equipment is corrosion or other degradation or weakening of the tubulars. A conventional well includes a variety of tubulars, including casing strings of differing types, injection tubulars, and production tubulars. Each of these tubulars present different types of failure risks, which are presented by different conditions. One exemplary tubular failure that complicates hydrocarbon recovery operations is acid corrosion. Acid corrosion of metal tubulars occurs when aqueous fluids containing gases such as hydrogen sulfide and/or carbon dioxide contact the metal surface. Another exemplary contributor to tubular failure is common oxidation or rusting of the metal surface, which can occur when the metal surface is exposed to water.

Conventional operations utilize packer fluids between tubulars to provide various benefits, including pressure stabilization and balancing across the tubulars and corrosion resistance. Conventional packer fluids are oil-based systems owing to the increased risk of oxidative corrosion of an aqueous environment. These packer fluids often are disposed between casing strings and production and/or injection tubulars. Presuming the packer fluids themselves are non-corrosive and presuming the casing strings and the production/injection tubulars maintain their integrity, the inner surfaces of the annulus between the casing and the tubulars should not be subject to corrosion related failures. However, it is not uncommon for one or more tubular or casing to develop a small leak. For example, the fluids in the produced fluids in the production tubular may create an opening in the production tubular and begin to leak into the annulus where the packer fluid is disposed. Additionally or alternatively, the formation fluids may enter through the casing string. In either event, the introduction of formation or production fluids into the packer fluid of the annulus exposes the interior surfaces of these tubulars to corrosive components, such as water, carbon dioxide, and/or hydrogen sulfide. While a single, small leak in the production tubular presents a number of risks, those risks can be contained for a significant time. However, long-term exposure to corrosive materials in the annular space risks corrosive failure of the tubular.

While the use of oil-based packer fluids presents a non-corrosive environment, it does not facilitate sequestration or containment of aqueous fluids that may enter the annulus. For example, the aqueous fluids will remain separate from the oil-based fluids and will tend to stay on the periphery of the oil-based composition, which positions the aqueous fluids against the tubulars. Moreover, in the event that the incoming fluids contain hydrogen sulfide and/or carbon dioxide, such components are typically contained in the aqueous phase and will similarly be positioned near the tubulars where their corrosive effects will be most damaging.

Sulfide stress cracking is one common failure when hydrogen sulfide gas and water are allowed to contact tubulars for extended periods. While various amine-based scavengers have been used in other industries to scavenge or sequester the hydrogen sulfide gas away from the aqueous streams, such scavengers are water soluble only and not suitable for use in the conventional oil-based packer fluids.

Accordingly, the need exists for systems and methods to protect the tubular goods from corrosion and/or failure induced by contact with one or more harmful compositions. For example, systems or methods to protect casing strings from produced hydrogen sulfide and/or from produced or injected water would prolong the viable life of the casing string.

Other related material may be found in at least the following patents: U.S. Pat. No. 4,359,391, U.S. Pat. No. 4,718,942, U.S. Pat. No. 5,169,598, U.S. Pat. No. 5,174,913, U.S. Pat. No. 5,250,225, U.S. Pat. No. 5,336,441, U.S. Pat. No. 5,411,670, U.S. Pat. No. 5,456,767, U.S. Pat. No. 5,637,557, U.S. Pat. No. 5,759,966, U.S. Pat. No. 5,945,164, U.S. Pat. No. 6,197,075, U.S. Pat. No. 7,216,710, U.S. Pat. No. 7,407,915, U.S. Pat. No. 7,615,516, and JP54102253A. Further, additional information may also be found in the following patent publications: WO08030758 A1, WO04059037 A2, US20060194700, US20090029155, and US20090236263.

### SUMMARY

In some implementations of the present disclosure, the inventions included herein are directed to guard bed compositions for protecting metal surfaces in a wellbore from corrosion. The guard bed compositions may comprise a variety of constituent components. Exemplary guard bed compositions may include: one or more surfactants selected from the group comprising amine surfactants; one or more co-surfactants selected from the group comprising C3 to C15 alcohols; and one or more non-surfactant amines.

Additionally or alternatively, exemplary guard bed compositions may comprise: a hydrocarbon fluid and an overbased detergent. In such compositions, the overbased detergent may be selected to form a colloidal coating on the metal surface upon contact with hydrogen sulfide and water.

Additionally or alternatively, exemplary guard bed compositions may comprise: a hydrocarbon fluid; one or more surfactants; one or more co-surfactants; and one or more non-surfactant amines. The one or more surfactants may be selected from the group comprising alkyl alkoxylated surfactants. The one or more co-surfactants may be selected from the group comprising C3 to C15 alcohols.

Still additionally or alternatively, exemplary guard bed compositions may comprise: a hydrocarbon fluid and one or more associating surface active polymers selected from the group comprising amphiphilic polymers. In such compositions, wherein the associating surface active polymers may comprise a hydrocarbon backbone with pendant polar groups.

The present disclosure is further directed to methods of preparing guard bed compositions and methods of protecting metal surfaces in a wellbore using guard bed compositions. Such methods may be adapted depending on the nature of the guard bed composition, as will be better understood from the discussion herein.

### BRIEF DESCRIPTION OF THE DRAWINGS

The foregoing and other advantages of the present technique may become apparent upon reading the following detailed description and upon reference to the drawings in which:

FIG. 1 is a schematic representation of a completed wellbore showing various tubulars installed therein.

### DETAILED DESCRIPTION

In the following detailed description, specific aspects and features of the present invention are described in connection with several embodiments. However, to the extent that the following description is specific to a particular embodiment or a particular use of the present techniques, it is intended to be illustrative only and merely provides a concise description of exemplary embodiments. Moreover, in the event that a particular aspect or feature is described in connection with a particular embodiment, such aspects and features may be found and/or implemented with other embodiments of the present invention where appropriate. Accordingly, the invention is not limited to the specific embodiments described below, but rather; the invention includes all alternatives, modifications, and equivalents falling within the scope of the appended claims.

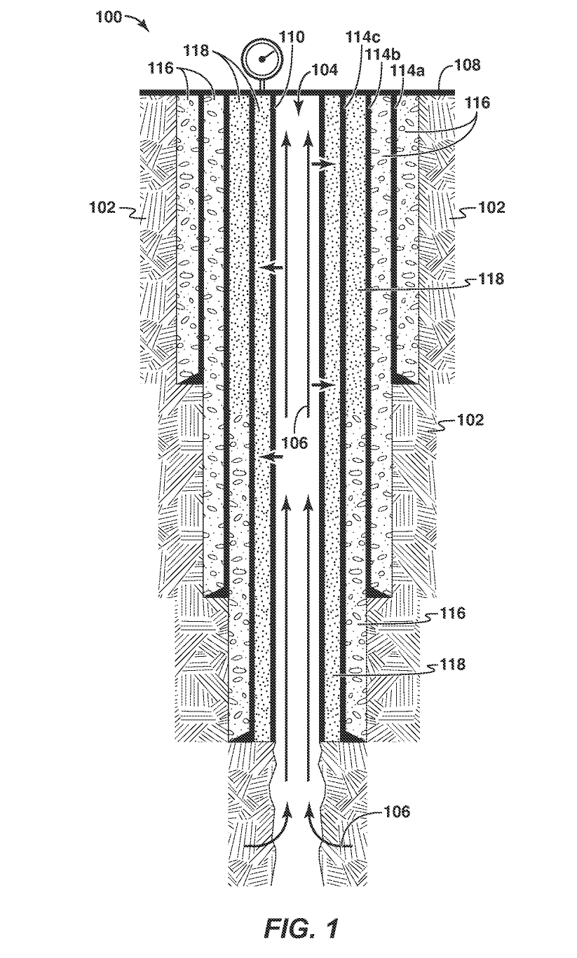

The present disclosure provides guard bed compositions for use in hydrocarbon recovery operations and associated methods for using the same. As such, FIG. 1 provides a schematic view of a completed wellbore, such as may be used in hydrocarbon recovery operations. While FIG. 1 illustrates the wellbore in operation as a production well, the functionality of the present compositions and the methods of using the present compositions are applicable to wellbores in any operating condition, such as during production operations, during treatment or workover operations, or during injection operations. FIG. 1 represents the wellbore somewhat schematically as the interrelationships between the hardware components in the wellbore are not critical to the compositions disclosed herein or the methods of using the present compositions. Nevertheless, to provide a context for discussion purposes, the general components of a wellbore are described here.

FIG. 1 illustrates a wellbore 100 has been drilled and completed into a subsurface formation 102. As used herein, the term wellbore 100 refers to the multitude of components and cavities extending into the subsurface, including the equipment associated therewith. In the schematic illustration of FIG. 1, the wellbore 100 includes a borehole 104 through which production fluids 106 travel to the surface 108, which may be any surface of the earth (e.g., land, sea bed, etc.). The borehole 104 is defined in FIG. 1, but a production tubular 110 that extends from the surface 108 to the beginning of an open-hole section 112, at which point the formation itself defines the borehole 104. The wellbore 100 further includes multiple casing strings 114 extending from the surface to varying depths, as is customary in drilling operations. Of course the number and relative length of casing strings 114 and production tubulars 110 in FIG. 1 are representative only and are not drawn to scale. Accordingly, many variations on the schematic of FIG. 1 are within the scope of the present disclosure. For example, the schematic of FIG. 1 is intentionally simplified and omits the multitude of equipment that may be included in a conventional wellbore, such as the surface equipment, packers, connections, etc. The simplified illustration of FIG. 1 is used to more clearly illustrate an exemplary use of the present compositions, which may be extended to uses in connection with many of the pieces of equipment used in hydrocarbon recovery operations.

In the exemplary wellbore 100 of FIG. 1, casing strings 114a and 114b are cemented in place with cement 116, in any conventional manner. Similarly, casing string 114c is cemented in place with cement 116 in the lower region thereof. Additionally, FIG. 1 illustrations at least two possible uses of the guard bed compositions 118 disclosed herein. As illustrated, the guard bed composition 118 may be disposed between the production tubular 110 and the innermost casing string 114c. Additionally or alternatively, the guard bed composition 118 may be disposed between two adjacent casing strings, such as casing strings 114c and 114b. As illustrated, the guard bed composition 118 and the cement 116 is vertically stacked in the annulus between casing strings 114c and 114b, with the guard bed composition 118 being positioned vertically above the cement 116. Depending on the wellbore and the relationships between the various components in the wellbore, the guard bed composition 118 and the cement 116 may be disposed in an annulus, or in annuli, in virtually in any manner. For example, guard bed compositions disposed in vertical sections of a wellbore may have different implementations than guard bed compositions disposed in horizontal or deviated sections of the wellbore. However, as will be understood by the description herein, the guard bed composition 118, regardless of where in the wellbore it is implemented, will be disposed in fluid communication with at least one metal surface, such as metal surfaces of the casing strings, production tubulars, or other metal surfaces that may be associated with the hydrocarbon recovery operations and/or equipment. For example, in the event that a packer is incorporated in the wellbore completion equipment, the guard bed composition may be disposed adjacent to the packer, whether the packer is between casing strings, between a casing string and a production/injection tubular, between a production/injection tubular and a formation surface, between a liner and a formation surface, or in any other conventional manner. The guard bed compositions of the present disclosure may be utilized in association with any metal surface where the functionality of the guard bed composition may prove useful, such as by preventing or delaying acid-induced or oxidation-induced corrosion.

Additionally, it will be noted that FIG. 1 is schematic as to how the guard bed composition is injected or otherwise provided to the wellbore. Still further, FIG. 1 is schematic with respect to containment devices or structures that may be utilized to keep the guard bed composition 118 in its intended location. It should be understood that any variety of wellbore tools, structures, and/or devices may be utilized in positioning and/or maintaining the guard bed composition in is intended location. Those of ordinary skill in the art will recognize the applicability and adaptations that may be necessary to provide the present guard bed compositions into the wellbore where desired.

Accordingly, it should be understood that the present disclosure is directed to compositions configured and selected to prevent corrosion or at least substantially reduce corrosion rates of metal surfaces in hydrocarbon recovery operations. Moreover, the present disclosure is directed to methods of preparing such compositions and fluids and to methods of utilizing such compositions and fluids in hydrocarbon recovery operations. The present disclosure encompasses a diversity of compositions having the desired functionality of reducing corrosion of the metal surfaces. However, all of these compositions may be understood to be related in a variety of manners, such as the manner of utilization, the manner of preparation, and the functionality thereof. Accordingly, the commonalities of the various compositions will be described at the outset followed by more particular attention to specific fluid compositions that may be prepared and/or used within the scope of the present disclosure.

As illustrated in FIG. 1, the guard bed composition 118 fills the annulus between two metal surfaces to protect the metal surfaces from corrosion. The metal surfaces in FIG. 1 are generally made of steel, as is customary in hydrocarbon recovery operations. As described above, the guard bed composition 118 of the present disclosure may protect against corrosion induced by water contact, hydrogen sulfide contact, or contact with both water and hydrogen sulfide. The water and/or hydrogen sulfide may be carried into the annulus by produced fluids, such as oil, water, gas, etc. While every effort is made to prevent leaks in the casing strings 114 and production tubular 110, such leaks occur from time-to-time.

A leak of water and/or hydrogen sulfide gas into the annulus, such as may be carried in the produced fluid, can be taken up by the guard bed composition 118 of the present disclosure. The uptake of water by the present compositions may prevent the water from contacting the metal surface. In many implementations of the present disclosure, the guard bed compositions 118 may be adapted to micro-emulsify aqueous fluids in contact with the compositions 118. In some implementations, the guard bed compositions 118 are selected to at least substantially instantaneously micro-emulsify the aqueous fluids entering the annulus. For example, greater than about 95% of the aqueous fluid may be micro-emulsified in less than about 5 seconds. Additionally or alternatively, greater than about 95% of the aqueous fluid may be micro-emulsified in less than about 1 second. Still further, in some implementations, the guard bed compositions of the present disclosure may be selected to micro-emulsify greater than about 95% of the entering aqueous fluid in less than about 0.1 seconds. While all micro-emulsifying compositions will have an upper limit to the amount emulsified fluid that can be taken up, the guard bed compositions 118 of the present disclosure may be adapted to micro-emulsify aqueous fluid up to an aqueous fluid to guard bed composition ratio of about 3:1. As used herein, micro-emulsification refers to any process by which the entering fluids or gases, such as water or hydrogen sulfide, are formed into droplets having a diameter less than about 5 microns. In some implementations, the droplets may range from about 100 nanometers to about 5 micrometers in diameter. Additionally or alternatively, the micro-emulsified droplets may range between about 100 nanometers and about 1000 nanometers in diameter. Other diameter ranges within these exemplary ranges are also available.

The guard bed compositions 118 of the present disclosure may take up brine compositions containing other components. For example, the brine compositions may contain water and NaCl in the range of about 1 to about 12 wt %. The total dissolved solids in the brine composition may range between about 0.01 wt % and about 30 wt % based upon the weight of the brine composition. Exemplary dissolved solids that may be found in the brine compositions include those solids common in produced water, such as chloride salts of sodium, calcium, magnesium, potassium, lithium, or cesium. Additionally or alternatively, the dissolved solids may include sulfate, carbonate, and bicarbonate salts of sodium, calcium, magnesium, potassium, lithium, or cesium.

Additionally or alternatively, hydrogen sulfide may also be taken up by the present compositions, thereby preventing contact between the hydrogen sulfide and the metal surface. Accordingly, in some implementations, the present compositions may be said to scrub hydrogen sulfide from the incoming fluids. Depending on the specific components of the compositions described herein, the present compositions may protect the metal surfaces from hydrogen sulfide by reacting with or otherwise binding the hydrogen sulfide directly or by emulsifying the water in which the hydrogen sulfide is carried. Regardless of the mechanism, the hydrogen sulfide, or at least a majority of the hydrogen sulfide, is kept away from the metal surface and is unable to corrode the metal surface.

One exemplary composition within the scope of the present disclosure is an amine surfactant based composition. For example, a guard bed composition within the scope of the present disclosure may comprise: one or more surfactants selected from the group comprising amine surfactants; one or more co-surfactants selected from the group comprising C3 to C15 alcohols; and one or more non-surfactant amines.

In some implementations, the guard bed composition may further include a hydrocarbon fluid. In implementations including a hydrocarbon fluid, the hydrocarbon fluid may comprise between about 0 wt % and about 90 wt % based on the weight of the guard bed composition. The hydrocarbon fluid may comprise hydrocarbons selected from the group of normal and branched alkane hydrocarbons having between 8 and 20 carbons. In some implementations, the hydrocarbon fluid may comprise an ultra low aromatic fluid. For example, the hydrocarbon fluid of the guard bed composition may comprise less than about 1 wt % aromatic compounds. One non-limiting example of a preferred hydrocarbon fluid is an oil sold by ExxonMobil Chemical Company under the name Escaid. Escaid 110 and 240 oils may be preferred. Other suitable hydrocarbon fluids that may be used include cyclic saturated and unsaturated hydrocarbons and synthetic oils, such as poly alpha olefins (PAO's).

Additionally or alternatively, in some implementations, the guard bed composition may further comprise water. The water may comprise between about 0 wt % and about 50 wt % based on the weight of the guard bed composition.

As described above, the guard bed composition may include amine surfactants, which may include at least one amine surfactant selected from the group comprising primary, second, tertiary, and quaternary amine surfactants. Preferably, a mixture of surfactants may be used wherein the mixture comprises a mixture of alkyl groups and mixture of alkoxylate groups. The amine surfactants may comprise alkyl amine ethoxylate surfactants. As a more specific example, the alkyl amine ethoxylate surfactants may include an alkyl group selected from the group comprising normal alkyl groups, branched alkyl groups, and alkyl aromatic groups. In some implementations, alkyl amine ethoxylate surfactants wherein the alkyl group comprises 6 to 20 carbons and the number of ethoxy groups vary from 2 to 50 may be utilized.

Additionally or alternatively, the amine surfactants may comprise at least one surfactant selected from the group comprising polymeric amine surfactants. For example, the polymeric amine surfactants may comprise compounds of the general structure R—X, wherein R is a hydrocarbon alkyl group and wherein X is an oligomeric amine or a polymeric amine having at least two amine functionality. Exemplary polymeric amine surfactants may be selected from the group of oligomeric surfactants comprising oleyl diethylene triamine, oleyl tetraethylene pentamine, dodecyl diethylene triamine, and dodecyl tetraethylene pentamine. Additionally or alternatively, the polymeric amine surfactant may be selected from the group of polymeric surfactants comprising polyisobutylene polyamine and polypropylene polyamine. In some implementations, the polymeric amine surfactant may have a molecular weight ranging from about 800 to about 3500.

In some implementations, the polymeric amine surfactant of the guard bed composition may be selected to bind to hydrogen sulfide to form a polyamine-hydrogen sulfide complex when contacted by hydrogen sulfide. Additionally, the polymeric amine surfactant may be selected to provide a polyamine-hydrogen sulfide complex that is adapted to capture water as a polyamine-hydrogen sulfide-water complex when contacted by water.

Co-surfactants suitable for use in amine surfactant based guard bed compositions may include alcohols selected from the group consisting of C3 to C15 alcohols. The alcohols can be linear or branched hydrocarbon chain alcohols or mixtures thereof.

As described above, the guard bed compositions of the present disclosure include non-surfactant amines. The non-surfactant amines may be selected from the group comprising alkyl primary amines, alkyl secondary amines, and alkyl tertiary amines. In some implementations, the non-surfactant amines may be hindered. The non-surfactant amine may be a hydrogen sulfide scrubber. For example, the non-surfactant amine may be tertiary butyl diethanol amine. Any amine capable of selectively scrubbing hydrogen sulfide is preferred.

While the emulsification rates described above may be accomplished in a number of manners utilizing the amine surfactant based guard bed compositions, in some implementations the one or more amine surfactants and the one or more co-surfactants are selected to at least substantially instantaneously micro-emulsify aqueous fluids in contact with the composition. The amine surfactant based guard bed compositions may be configured to provide the functionality described above.

The amine surfactant based guard bed compositions described above may be prepared in a number of manners. An exemplary method of preparing a suitable guard bed composition may comprise: obtaining one or more surfactants selected from the group comprising amine surfactants; obtaining one or more co-surfactants selected from the group comprising C3 to C15 alcohols; obtaining one or more non-surfactant amines; and mixing the surfactants, the co-surfactants, and the non-surfactant amines. The surfactants, co-surfactants, and non-surfactant amines obtained in the method of preparing the guard bed compositions may be as described above. Moreover, the methods of preparing an amine surfactant based guard bed composition may further include obtaining a hydrocarbon fluid and/or water and mixing the surfactants, co-surfactants, and non-surfactant amines in the water and/or hydrocarbon fluid. When water is incorporated into the guard bed compositions, the water may be micro-emulsified by the surfactants and the co-surfactants.

Additionally or alternatively, the amine surfactant based guard bed compositions described above may be incorporated in a method of protecting a metal surface in a wellbore. The method may include obtaining an amine surfactant based guard bed composition as described above and disposing the guard bed composition adjacent to a metal surface in a wellbore. The method may further include producing hydrocarbons through the wellbore.

Additionally or alternatively guard bed compositions within the scope of the present disclosure may be described summarily as overbased detergent based guard bed compositions. Overbased detergent based guard bed compositions may be prepared and configured to provide the functionality described above. Specifically, the overbased detergent based guard bed compositions may be adapted to protect a metal surface in a wellbore from corrosion related to contact with water and/or hydrogen sulfide. In the interest of brevity, and as described above, the functionality of the guard bed compositions will not be repeated here but is understood to be provided by the overbased detergent based guard bed compositions, mutatis mutandis, as well as to the remaining guard bed compositions described herein.

Overbased detergent based guard bed compositions include a hydrocarbon fluid; and an overbased detergent. The overbased detergent is selected to form a colloidal coating on the metal surface upon contact with hydrogen sulfide and water. The relative concentrations of hydrocarbon fluid and overbased detergent may be measured by weight. The overbased detergent may comprise greater than about 20 wt % of the guard bed composition based on the weight of the guard bed composition. For example, the overbased detergent may comprise between about 20 wt % and about 99 wt % of the guard bed composition. In some implementations, the guard bed composition may further comprise at least one co-surfactant selected from the group comprising C3 to C15 alcohols. The co-surfactant alcohols may be selected from the group comprising branched alcohols, linear alcohols, and mixtures thereof.

The hydrocarbon fluid of the overbased detergent based guard bed composition may comprise hydrocarbons selected from the group comprising normal and branched alkane hydrocarbons having C8 to C20 carbons, cyclic alkanes, synthetic oils, and mixtures thereof. As one example, the hydrocarbon fluid may comprise an ultra low aromatic fluid. For example, the hydrocarbon fluid may comprise less than about 1 wt % aromatic compounds. One non-limiting example of a preferred hydrocarbon fluid is a hydrocarbon fluid sold by ExxonMobil Chemical Company under the name Escaid. Escaid 110 and 240 hydrocarbon fluids are preferred. Escaid 110 is more preferred and comprises a mixture of linear hydrocarbons with C12 hydrocarbons being the major component of the mixture. Cyclic saturated and unsaturated hydrocarbons may also be used. Synthetic oils such as poly alpha olefins (PAO's) may also be used.

The guard bed compositions referred to herein as overbased detergent based guard bed compositions incorporate detergent compounds of the structure R-M_{N}, wherein N is greater than about 1. In some implementations, M is an inorganic compound. In exemplary, non-limiting implementations, the inorganic compound is a metal base selected from the group comprising CaO, MgO, BaO, ZnO, CaCO3, MgCO3, BaCO3, and ZnCO3. In some implementations, R is a linear or branched surfactant selected to stabilize the metal base. R may comprise surfactant having the structure S—Y, wherein S is a linear or branched C8 to C24 alkyl hydrocarbon group and Y is a polar group selected from the group comprising arylamines, phenates, salicylates, amines, and hydroxides. In this context, for example, the term “overbased” is meant to signify that the amount of base in the composition is greater than the stoichiometric equivalent required to neutralize the arylamines, phenates, salicylates, amines, and hydroxides and mixtures thereof. The overbased detergent may be selected to at least substantially instantaneously micro-emulsify aqueous fluids that come into contact with the guard bed composition.

For illustrative purposes, several more specific examples of overbased detergent guard bed compositions are described herein. While these examples are suitable and numerous, they are not intended to be an exhaustive listing of the overbased detergent guard bed compositions within the scope of the present disclosure. One illustrative composition may include CaO as the base and dodecyl benzene sulfonic acid as the stabilizer with Escaid 110 as the hydrocarbon fluid. Other suitable examples may include: 1) CaO as the base and dodecyl salicylic acid as the stabilizer with Escaid 110 as the hydrocarbon fluid; 2) CaO as the base and nonyl phenol as the stabilizer with Escaid 110 as the hydrocarbon fluid; 3) CaO as the base and dodecyl carboxylic acid as the stabilizer with Escaid 110 as the hydrocarbon fluid; 4) MgO as the base and dodecyl benzene sulfonic acid as the stabilizer with Escaid 110 as the hydrocarbon fluid; 5) MgO as the base and dodecyl salicylic acid as the stabilizer with Escaid 110 as the hydrocarbon fluid; 6) MgO as the base and nonyl phenol as the stabilizer with Escaid 110 as the hydrocarbon fluid; 7) wherein MgO as the base and dodecyl carboxylic acid as the stabilizer with Escaid 110 as the hydrocarbon fluid; 8) MgO as the base and dodecyl benzoic acid as the stabilizer with Escaid 110 as the hydrocarbon fluid; or 9) CaO as the base and dodecyl benzoic acid as the stabilizer with Escaid 110 as the hydrocarbon fluid. As still further examples, any of the guard bed compositions described above may be prepared by replacing the Escaid 110 with Escaid 240 or a poly alpha olefin (PAO) as the hydrocarbon fluid.

As with the amine surfactant based guard bed compositions, the overbased detergent guard bed compositions may be prepared in any suitable manner. For example, a suitable hydrocarbon fluid and a suitable overbased detergent may be mixed in suitable proportions to prepare the guard bed composition. The method may further include adding suitable co-surfactant(s) to the mixture. In preparing the guard bed composition, the overbased detergent and the quantity thereof may be selected to form a colloidal coating a metal surface when the guard bed composition is contacted by water and hydrogen sulfide.

Still further, the overbased detergent based guard bed compositions may be utilized in methods of protecting metal surfaces in a wellbore. For example, the overbased detergent based guard bed composition described above may be obtained and disposed adjacent to a metal surface in a wellbore. Hydrocarbons may then be produced through the wellbore. The overbased detergent forming a colloidal coating on the surface and the overbased detergent in solution are both available to provide protection to the metal surface. The overbased detergent in solution provides the first layer of protection and the overbased detergent on the surface provides the second layer of protection.

As with the other guard bed compositions described herein, the overbased detergent based guard bed compositions described above may be adapted to take up large amounts of water, or to have a high water uptake property. The water uptake ability described herein, in the context of all of the guard bed compositions described herein, is intended to encompass water uptake by way of its ability to solubilize, disperse, emulsify, micro-emulsify, and combinations thereof the water coming into contact with the guard bed composition, such as through a leak in a casing string, production tubular, or other component of the well completion equipment.

Additionally or alternatively guard bed compositions within the scope of the present disclosure may be described summarily as alkyl alkoxylated surfactant based guard bed compositions. Alkyl alkoxylated surfactant based guard bed compositions may be prepared and configured to provide the functionality described above. Specifically, the alkyl alkoxylated surfactant based guard bed compositions may be adapted to protect a metal surface in a wellbore from corrosion related to contact with water and/or hydrogen sulfide. In the interest of brevity, and as described above, the functionality of the guard bed compositions will not be repeated here but is understood to be provided by the alkyl alkoxylated surfactant based guard bed compositions, mutatis mutandis, as well as to the remaining guard bed compositions described herein.

Exemplary alkyl alkoxylated surfactant based guard bed compositions for protecting a metal surface in a wellbore from corrosion comprises: a hydrocarbon fluid; one or more surfactants selected from the group comprising alkyl alkoxylated surfactants; one or more co-surfactants selected from the group comprising C3 to C15 alcohols; and one or more non-surfactant amines. The hydrocarbon fluid may be present in a suitable amount, measured by weight, to constitute between about 0 wt % and about 90 wt % of the guard bed composition. The co-surfactant alcohols can be linear or branched hydrocarbon chain alcohols or mixtures thereof. In some implementations, the alkyl alkoxylated surfactant based guard bed compositions may further comprise water, such as between about 0 wt % and about 50 wt % based on the total weight of the guard bed composition.

The hydrocarbon fluid of the alkyl alkoxylated surfactant based guard bed composition may comprise hydrocarbons selected from the group comprising normal and branched alkane hydrocarbons having C8 to C20 carbons, cyclic alkanes, synthetic oils, and mixtures thereof. As one example, the hydrocarbon fluid may comprise an ultra low aromatic fluid. For example, the hydrocarbon fluid may comprise less than about 1 wt % aromatic compounds. One non-limiting example of a preferred hydrocarbon fluid is a hydrocarbon fluid sold by ExxonMobil Chemical Company under the name Escaid. Escaid 110 and 240 hydrocarbon fluids are preferred. Escaid 110 is more preferred and comprises a mixture of linear hydrocarbons with C12 hydrocarbons being the major component of the mixture. Cyclic saturated and unsaturated hydrocarbons may also be used. Synthetic oils such as poly alpha olefins (PAO's) may also be used.

The alkyl alkoxylated surfactants of the alkyl alkoxylated surfactant based guard bed compositions may comprise at least one surfactant selected from the group comprising alkyl and alkyl aromatic alkoxylated surfactants. The alkyl group may preferably have C8 to C20 carbons and mixtures thereof, or more preferably between C12 and C18 carbons and mixtures thereof. The alkoxylate group may be selected from the group comprising ethylene oxide, propylene oxide, butylene oxide and mixtures thereof. The alkoxide group may be ethoxylate. In some implementations, it may be preferred to use a mixture of surfactants wherein the mixture comprises a mixture of alkyl groups and mixture of alkoxylate groups. Exemplary alkyl alkoxylated surfactants include alkyl ethoxylate surfactants wherein the alkyl group comprises 6 to 20 carbons and the number of ethoxy groups varies from 2 to 50. Other illustrative examples of alkyl alkoxylated surfactants are alkyl sorbitan alkoxylates, alkyl alcohol ethoxylates, alkyl acid ethoxylates and alkyl nonylphenol ethoxylates. The alkyl alkoxylated surfactant based guard bed composition may comprise mixtures of the illustrative examples provided herein or other alkyl alkoxylate surfactants fitting the descriptions provided herein. While many examples of alkyl alkoxylated surfactants are provided herein, some implementations may select the one or more alkyl alkoxylated surfactants and the one or more co-surfactants to form an oil continuous surfactant liquid crystalline mesophase upon interaction of the guard bed composition with aqueous fluids.

As introduced above, the alkyl alkoxylated surfactant based guard bed compositions within the scope of the present disclosure comprise non-surfactant amines. Exemplary non-surfactant amines may be selected from the group comprising alkyl primary amines, alkyl secondary amines, and alkyl tertiary amines. The non-surfactant amines may be hindered or non-hindered. Hindered amines may be preferred in some implementations. Still further, some implementations may prefer alkoxylated amines. The non-surfactant amine may be a hydrogen sulfide scrubber. One exemplary non-surfactant amine suitable for use in the present compositions is tertiary butyl diethanol amine.

As with the other guard bed compositions described herein, the alkyl alkoxylated surfactant based guard bed compositions may be prepared in any suitable manner. For example, suitable hydrocarbon fluids, suitable alkyl alkoxylated surfactants, suitable co-surfactants, and suitable non-surfactant amines may be mixed in suitable proportions to prepare the guard bed composition. In preparing the guard bed composition, the one or more alkyl alkoxylated surfactants and the one or more co-surfactants and the quantity thereof may be selected to form an oil continuous surfactant liquid crystalline mesophase upon interaction of the guard bed composition with aqueous fluids.

Still further, the alkyl alkoxylated surfactant based guard bed compositions may be utilized in methods of protecting metal surfaces in a wellbore. For example, the alkyl alkoxylated surfactant based guard bed composition described above may be obtained and disposed adjacent to a metal surface in a wellbore. Hydrocarbons may then be produced through the wellbore.

As with the other guard bed compositions described herein, the alkyl alkoxylated surfactant based guard bed compositions described above may be adapted to take up large amounts of water, or to have a high water uptake property. The water uptake ability described herein, in the context of all of the guard bed compositions described herein, is intended to encompass water uptake by way of its ability to solubilize, disperse, emulsify, micro-emulsify, and combinations thereof the water coming into contact with the guard bed composition, such as through a leak in a casing string, production tubular, or other component of the well completion equipment.

Additionally or alternatively guard bed compositions within the scope of the present disclosure may be described summarily as surface active polymer based guard bed compositions. Surface active polymer based guard bed compositions may be prepared and configured to provide the functionality described above. Specifically, the surface active polymer based guard bed compositions may be adapted to protect a metal surface in a wellbore from corrosion related to contact with water and/or hydrogen sulfide. In the interest of brevity, and as described above, the functionality of the guard bed compositions will not be repeated here but is understood to be provided by the surface active polymer based guard bed compositions, mutatis mutandis, as well as to the remaining guard bed compositions described herein.

Exemplary surface active polymer based guard bed compositions for protecting a metal surface in a wellbore from water and/or hydrogen sulfide induced corrosion include a hydrocarbon fluid and one or more associating surface active polymers selected from the group comprising amphiphilic polymers. The surface active polymer based guard bed composition may include between about 0.1 wt % and about 10 wt % surface active polymer based on the total weight of the guard bed composition.

The hydrocarbon fluid of the surface active polymer based guard bed composition may comprise hydrocarbons selected from the group comprising normal and branched alkane hydrocarbons having C8 to C20 carbons, cyclic alkanes, synthetic oils, and mixtures thereof. As one example, the hydrocarbon fluid may comprise an ultra low aromatic fluid. For example, the hydrocarbon fluid may comprise less than about 1 wt % aromatic compounds. One non-limiting example of a preferred hydrocarbon fluid is a hydrocarbon fluid sold by ExxonMobil Chemical Company under the name Escaid. Escaid 110 and 240 hydrocarbon fluids are preferred. Escaid 110 is more preferred and comprises a mixture of linear hydrocarbons with C12 hydrocarbons being the major component of the mixture. Cyclic saturated and unsaturated hydrocarbons may also be used. Synthetic oils such as poly alpha olefins (PAO's) may also be used.

The associating surface active polymers of the guard bed composition may comprise a hydrocarbon backbone with pendant polar groups. One feature of these polymers is that they associate or aggregate in the oily continuous phase such that the polar groups are attracted towards each other and form micro-domains of polarity in an oil continuous medium. These micro-domains of polarity provide the sites for micro-emulsification of water. The associating surface active polymers may be selected from the group comprising poly acrylic acid, partially hydrolyzed poly acryl amide, poly ethylene glycol, and mixtures thereof. Other suitable associating surface active polymers useful in the present disclosure include polymeric amine surfactants comprising compounds of general structure R—X wherein, R is a hydrocarbon alkyl group that is linear or branched, and X is a polymeric amine with at least two amine functionality. Some non-limiting examples of preferred polymeric amine surfactants are oleyl diethylene triamine, oleyl tetraethylene pentamine, dodecyl diethylene triamine, dodecyl tetraethylene pentamine, and polyisobutylene polyamine (also known as PIB-Amine, apolypropylene polyamine (also known as PP-Amine). The molecular weight of the polymeric amine can vary from 800 to 3500.

In some implementations, the surface active polymer based guard bed composition may further comprise surfactants selected from the group comprising alkyl sorbitans and alkyl sorbitan alkoxylated surfactants. For example, the surfactant may comprise a surfactant from the group comprising alkyl sorbitan ethoxylates. Additionally or alternatively, in some implementations, the surface active polymer based guard bed compositions may further comprise co-surfactants selected from the group comprising C3 to C15 linear and branched alcohols.

While surface active polymer based guard bed compositions may be prepared utilizing any suitable components fitting the descriptions provided herein, non-limiting representative surface active polymer based guard bed compositions may include compositions wherein: 1) the hydrocarbon oil is Escaid 110 and the associating surface active polymer is a polyisobutylene polyamine at 3 wt % concentration; 2) the hydrocarbon oil is Escaid 110 and the associating surface active polymer is a polypropylene polyamine at 3 wt % concentration; 3) the hydrocarbon oil is Escaid 110 and the associating surface active polymer is a 1:1 mixture of polyisobutylene polyamine and polypropylene polyamine; or 4) the hydrocarbon oil is Escaid 110 and the associating surface active polymer is a 1:1:1 mixture of polyisobutylene polyamine, polypropylene polyamine and polyethylene glycol. Additionally or alternatively, surface active polymer based guard bed compositions may be prepared as in examples 1-4 above, but may replace the Escaid 110 with Escaid 240 or with poly alpa olefin (PAO) synthetic oil.

As described above, the surface active polymer based guard bed compositions of the present disclosure may be configured to micro-emulsify water coming into contact with the guard bed compositions. In some implementations, interaction between the guard bed composition and leaked aqueous fluids substantially immediately encapsulates substantially all of the aqueous fluids in micro-domains formed by the associating surface active polymers. The formation of micro-domains by the surface active polymers may form a gel-like structure. Such a gel formation ability may be particularly desirable for protecting a metal surface from corrosion.

As with the other guard bed compositions described herein, the surface active polymer based guard bed compositions may be prepared in any suitable manner. For example, suitable hydrocarbon fluids and suitable surface active polymers may be mixed in suitable proportions to prepare the guard bed composition. In preparing the guard bed composition, the one or more associating surface active polymers and the quantity thereof may be selected to form encapsulating micro-domains upon interaction of the guard bed composition with aqueous fluids. Additionally or alternatively, the one or more associating surface active polymers and the quantity thereof may be selected to form a gel-like structure to protect the metal surface.

Still further, the surface active polymer based guard bed compositions may be utilized in methods of protecting metal surfaces in a wellbore. For example, the surface active polymer based guard bed composition described above may be obtained and disposed adjacent to a metal surface in a wellbore. Hydrocarbons may then be produced through the wellbore.

As with the other guard bed compositions described herein, the surface active polymer based guard bed compositions described above may be adapted to take up large amounts of water, or to have a high water uptake property. The water uptake ability described herein, in the context of all of the guard bed compositions described herein, is intended to encompass water uptake by way of its ability to solubilize, disperse, emulsify, micro-emulsify, and combinations thereof the water coming into contact with the guard bed composition, such as through a leak in a casing string, production tubular, or other component of the well completion equipment.

### EXAMPLES

Without limiting the generality of the foregoing discussion, the following numbered paragraphs, or the claims of the present application, the following examples are provided to illustrate exemplary details of various implementations that have been conducted based on the principles discussed above.

### Example 1

100 g of a first composition was prepared with the following components; monoethanol ammonium dodecylbenzene sulfonate (52.8 g), dodecyl diethanol ammonium dodecylbenzene sulfonate (27.2 g) and n-butanol (20.0 g). A 20 g of the first composition was mixed with 80 g of Escaid 110 to provide a guard bed composition, referred to herein as COMPOSITION-I. Several properties of the guard bed composition, COMPOSITION-I were experimentally determined and compared to Escaid 110. The experimentally determined properties of Escaid 110 and COMPOSITION-I are provided in Table 1 below. It can be observed that the guard bed composition of the instant invention has superior properties compared to Escaid 110 alone.

TABLE 1

| Properties | Escaid 110 | COMPOSITION-I |
|---|---|---|
| Physical Appearance | Clear Liquid | Clear Yellowish Liquid |
| Density @ 25 C. | 0.8 g/cc | 0.8 g/cc |
| Viscosity @ 25 C. | 1.9 cSt | 5.2 cSt |
| Stability | 70 C. to −70 C. | 70 C. to −70 C. |
| Emulsification Rate | None | Instantaneous |
| + Oil/Water Interfacial | 55 mN/m | <0.01 mN/m |
| Tension | | |
| Emulsification Range | None | 0.1% to 10% NaCl |
| Emulsification Capacity | None | Oil:Brine Ratio = 1:0.05 |
| | | to 1:1 |
| Emulsion Stability | N/A | 70 C. to −70 C. |
| + Dispersed Brine | N/A | <1 micron |
| Droplet Size | | |
| Emulsion Continuity | N/A | Oil Continuous |
| + Emulsion Character | Phase Separated | Water-in-Oil Micro- |
| | Water and Oil | emulsion |
| - Emulsion Conductivity | N/A | 10 mho's |
| - Wettability on Glass | Phase Sepatered | Emulsified Water Does |
| | Water Wets Glass | not Wet Glass |

### Example 2

100 g of a first composition was prepared with the following components: sorbitan mono-oleate (31.25 g), sorbitan mono-oleate [20] ethoxylate, which is a C18 alkyl sorbitan with 20 ethoxylate groups (62.5 g), and tertiary amyl alcohol (6.25 g). A 20 g of the first composition was mixed with 80 g of Escaid 110 to provide a guard bed composition, referred to herein as COMPOSITION-II. Several properties of the guard bed composition, COMPOSITION-II were experimentally determined and compared to Escaid 110. The experimentally determined properties of Escaid 110 and COMPOSITION-II are provided in Table 2 below. It can be observed that the guard bed composition of the instant invention has superior properties compared to Escaid 110 alone.

TABLE 2

| Properties | Escaid 110 | COMPOSITION-II |
|---|---|---|
| Physical Appearance | Clear Liquid | Clear Yellowish Liquid |
| Density @ 25 C. | 0.8 g/cc | 0.8 g/cc |
| Viscosity @ 25 C. | 1.9 cSt | 6.9 cSt |
| Stability | 70 C. to −70 C. | 70 C. to −70 C. |
| Emulsification Rate | None | Instantaneous |
| + Oil/Water Interfacial | 55 mN/m | <0.01 mN/m |
| Tension | | |
| Emulsification Range | None | 0.1% to 10% NaCl |
| Emulsification Capacity | None | Oil:Brine Ratio = 1:0.05 |
| | | to 1:0.2 |
| Emulsion Stability | N/A | 70 C. to −70 C. |
| + Dispersed Brine | N/A | <1 micron |
| Droplet Size | | |
| Emulsion Continuity | N/A | Oil Continuous |
| + Emulsion Character | Phase Separated | Water-in-Oil |
| | Water and Oil | |
| - Emulsion Conductivity | N/A | 10 mho's |
| - Wettability on Glass | Phase Separated | Emulsified Water Does |
| | Water Wets Glass | not Wet Glass |

While the present techniques of the invention may be susceptible to various modifications and alternative forms, the exemplary systems, methods, implementations, and embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

In the present disclosure, several of the illustrative, non-exclusive examples of methods and systems have been discussed and/or presented in the context of flow diagrams, or flow charts, in which the methods and/or systems are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities, other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” may mean A alone, B alone, C alone, A and B together, A and C together, B and C together, A, B and C together, and optionally any of the above in combination with at least one other entity.

Illustrative, non-exclusive examples of systems and methods according to the present disclosure are presented in the following enumerated paragraphs. It is within the scope of the present disclosure that the individual steps of the methods recited herein, including in the following enumerated paragraphs, may additionally or alternatively be referred to as a “step for” performing the recited action.

A1. A guard bed composition for protecting a metal surface in a wellbore from corrosion, the composition comprising:
one or more surfactants selected from the group comprising amine surfactants;
one or more co-surfactants selected from the group comprising C3 to C15 alcohols; and
one or more non-surfactant amines.

A2. The guard bed composition of paragraph A1 further comprising a hydrocarbon fluid.

A3. The guard bed composition of paragraph A2 wherein the hydrocarbon fluid comprises between about 0 wt % and about 90 wt % based on the weight of the guard bed composition.

A4. The guard bed composition of paragraph A3 further comprising water, wherein the water comprises between about 0 wt % and about 50 wt % based on the weight of the guard bed composition.

A5. The guard bed composition of paragraph A2 wherein the hydrocarbon fluid comprises hydrocarbons selected from the group of normal and branched alkane hydrocarbons having C8 to C20 carbons.

A6. The guard bed composition of paragraph A5 wherein the hydrocarbon fluid comprises an ultra low aromatic fluid.

A7. The guard bed composition of paragraph A6 wherein the hydrocarbon fluid comprises less than about 1 wt % aromatic compounds.

A8. The guard bed composition of paragraph A1 wherein the amine surfactants comprise at least one amine surfactant selected from the group comprising primary, second, tertiary, and quaternary amine surfactants.

A9. The guard bed composition of paragraph A8 wherein the amine surfactants comprise alkyl amine ethoxylate surfactants.

A10. The guard bed composition of paragraph A9 wherein the alkyl amine ethoxylate surfactants include an alkyl group selected from the group comprising normal alkyl groups, branched alkyl groups, and alkyl aromatic groups.

A11. The guard bed composition of paragraph A1 wherein the amine surfactants comprise at least one surfactant selected from the group comprising polymeric amine surfactants.

A12. The guard bed composition of paragraph A11 wherein the polymeric amine surfactants comprise compounds of the general structure R—X, wherein R is a hydrocarbon alkyl group and wherein X is an oligomeric amine or a polymeric amine having at least two amine functionality.

A13. The guard bed composition of paragraph A12 wherein the polymeric amine surfactant is selected from the group of oligomeric surfactants comprising oleyl diethylene triamine, oleyl tetraethylene pentamine, dodecyl diethylene triamine, and dodecyl tetraethylene pentamine.

A14. The guard bed composition of paragraph A12 wherein the polymeric amine surfactant is selected from the group of polymeric surfactants comprising polyisobutylene polyamine and polypropylene polyamine.

A15. The guard bed composition of paragraph A12 wherein the polymeric amine surfactant has a molecular weight ranging from about 800 to about 3500.

A16. The guard bed composition of paragraph A11 wherein the polymeric amine surfactant binds to hydrogen sulfide to form a polyamine-hydrogen sulfide complex when contacted by hydrogen sulfide.

A17. The guard bed composition of paragraph A16 wherein the polyamine-hydrogen sulfide complex is adapted to capture water as a polyamine-hydrogen sulfide-water complex when contacted by water.

A18. The guard bed composition of paragraph A1 wherein the non-surfactant amines are selected from the group comprising alkyl primary amines, alkyl secondary amines, and alkyl tertiary amines.

A19. The guard bed composition of paragraph A18 wherein the non-surfactant amines are hindered.

A20. The guard bed composition of paragraph A18 wherein the non-surfactant amine is a hydrogen sulfide scrubber.

A21. The guard bed composition of paragraph A20 wherein the non-surfactant amine is tertiary butyl diethanol amine.

A22. The guard bed composition of paragraph A1 wherein the one or more surfactants and the one or more co-surfactants are selected to at least substantially instantaneously micro-emulsify aqueous fluids in contact with the composition.

A23. The guard bed composition of paragraph A22 wherein the aqueous fluid is a brine composition, and wherein brine compositions introduced into the guard bed composition are micro-emulsified into droplets having a diameter less than about five microns in less than about five seconds.

A24. The guard bed composition of paragraph A23 wherein the droplets are between about 10 nanometers and about 5 micrometers in diameter.

A25. The guard bed composition of paragraph A24 wherein the droplets are between about 100 nanometers and about 1000 nanometers in diameter.

A26. The guard bed composition of paragraph A23 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

A27. The guard bed composition of paragraph A26 wherein the dissolved solids are selected from the group comprising salts of sodium, calcium, magnesium, potassium, lithium, and cesium.

A28. The guard bed composition of paragraph A22 wherein greater than about 95% of the aqueous fluid is micro-emulsified in less than about 5 seconds.

A29. The guard bed composition of paragraph A28 wherein greater than about 95% of the aqueous fluid is micro-emulsified in less than about 1 second.

A30. The guard bed composition of paragraph A29 wherein greater than about 95% of the aqueous fluid is micro-emulsified in less than about 0.1 seconds.

A31. The guard bed composition of paragraph A22 wherein the guard bed composition is adapted to micro-emulsify aqueous fluid up to an aqueous fluid:guard bed composition ratio of about 3:1.

B1. A method of preparing a guard bed composition adapted for the protection of a metal surface in a wellbore from sulfide stress cracking, the method comprising:
obtaining one or more surfactants selected from the group comprising amine surfactants;
obtaining one or more co-surfactants selected from the group comprising C3 to C15 alcohols;
obtaining one or more non-surfactant amines; and
mixing the surfactants, the co-surfactants, and the non-surfactant amines.

B2. The method of paragraph B1 further comprising obtaining a hydrocarbon fluid, and wherein the surfactants, the co-surfactants, and the non-surfactant amines are mixed in the hydrocarbon fluid.

B3. The method of paragraph B2 wherein the hydrocarbon fluid comprises between about 0 wt % and about 90 wt % based on the weight of the guard bed composition.

B4. The method of paragraph B2 wherein the hydrocarbon fluid comprises hydrocarbons selected from the group of normal and branched alkane hydrocarbons having C8 to C20 carbons.

B5. The method of paragraph B4 wherein the hydrocarbon fluid comprises an ultra low aromatic fluid.

B6. The method of paragraph B2 further comprising obtaining water, wherein the water is mixed in the hydrocarbon fluid and is micro-emulsified by the surfactants and the co-surfactants.

B7. The method of paragraph B6, wherein the water comprises between about 0 wt % and about 50 wt % based on the weight of the guard bed composition.

B8. The method of paragraph B1 wherein the amine surfactants comprise at least one amine surfactant selected from the group comprising primary, second, tertiary, and quaternary amine surfactants.

B9. The method of paragraph B8 wherein the amine surfactants comprise alkyl amine ethoxylate surfactants.

B10. The method of paragraph B9 wherein the alkyl amine ethoxylate surfactants include an alkyl group selected from the group comprising normal alkyl groups, branched alkyl groups, and alkyl aromatic groups.

B11. The method of paragraph B1 wherein the amine surfactants comprise at least one surfactant selected from the group comprising polymeric amine surfactants.

B12. The method of paragraph B11 wherein the polymeric amine surfactants comprise compounds of the general structure R—X, wherein R is a hydrocarbon alkyl group and wherein X is an oligomeric amine or a polymeric amine having at least two amine functionality.

B13. The method of paragraph B12 wherein the polymeric amine surfactant is selected from the group of oligomeric surfactants comprising oleyl diethylene triamine, oleyl tetraethylene pentamine, dodecyl diethylene triamine, and dodecyl tetraethylene pentamine.

B14. The method of paragraph B12 wherein the polymeric amine surfactant is selected from the group of polymeric surfactants comprising polyisobutylene polyamine and polypropylene polyamine.

B15. The method of paragraph B12 wherein the polymeric amine surfactant has a molecular weight ranging from about 800 to about 3500.

B16. The method of paragraph B11 wherein the polymeric amine surfactant binds to hydrogen sulfide to form a polyamine-hydrogen sulfide complex when contacted by hydrogen sulfide.

B17. The method of paragraph B16 wherein the polyamine-hydrogen sulfide complex is adapted to capture water as a polyamine-hydrogen sulfide-water complex when contacted by water.

B18. The method of paragraph B1 wherein the non-surfactant amines are selected from the group comprising alkyl primary amines, alkyl secondary amines, and alkyl tertiary amines.

B19. The method of paragraph B18 wherein the non-surfactant amines are hindered.

B20. The method of paragraph B18 wherein the non-surfactant amine is a hydrogen sulfide scrubber.

B21. The method of paragraph B20 wherein the non-surfactant amine is tertiary butyl diethanol amine.

B22. The method of paragraph B1 wherein the one or more surfactants and the one or more co-surfactants are selected to at least substantially instantaneously micro-emulsify aqueous fluids in contact with the composition.

B23. The method of paragraph B22 wherein the aqueous fluid is a brine composition, and wherein brine compositions introduced into the guard bed composition are micro-emulsified into droplets having a diameter less than about five microns in less than about five seconds.

B24. The method of paragraph B22 wherein the guard bed composition is adapted to micro-emulsify aqueous fluid up to an aqueous fluid:guard bed composition ratio of about 3:1.

C1. A method of protecting a metal surface in a wellbore from corrosion, the method comprising:
obtaining a guard bed composition comprising:
   one or more surfactants selected from the group comprising amine surfactants;
   one or more co-surfactants selected from the group comprising C3 to C15 alcohols; and
   one or more non-surfactant amines;
disposing the guard bed composition adjacent to a metal surface in a wellbore; and
producing hydrocarbons through the wellbore.

C2. The method of paragraph C1 wherein the guard bed composition comprises a hydrocarbon fluid.

C3. The method of paragraph C2 wherein the hydrocarbon fluid comprises between about 0 wt % and about 90 wt % based on the weight of the guard bed composition.

C4. The method of paragraph C3 wherein the guard bed composition further comprises water, wherein the water comprises between about 0 wt % and about 50 wt % based on the weight of the guard bed composition.

C5. The method of paragraph C2 wherein the hydrocarbon fluid comprises hydrocarbons selected from the group of normal and branched alkane hydrocarbons having C8 to C20 carbons.

C6. The method of paragraph C5 wherein the hydrocarbon fluid comprises an ultra low aromatic fluid.

C7. The method of paragraph C6 wherein the hydrocarbon fluid comprises less than about 1 wt % aromatic compounds.

C8. The method of paragraph C1 wherein the amine surfactants comprise at least one amine surfactant selected from the group comprising primary, second, tertiary, and quaternary amine surfactants.

C9. The method of paragraph C8 wherein the amine surfactants comprise alkyl amine ethoxylate surfactants.

C10. The method of paragraph C9 wherein the alkyl amine ethoxylate surfactants include an alkyl group selected from the group comprising normal alkyl groups, branched alkyl groups, and alkyl aromatic groups.

C11. The method of paragraph C1 wherein the amine surfactants comprise at least one surfactant selected from the group comprising polymeric amine surfactants.

C12. The method of paragraph C11 wherein the polymeric amine surfactants comprise compounds of the general structure R—X, wherein R is a hydrocarbon alkyl group and wherein X is an oligomeric amine or a polymeric amine having at least two amine functionality.

C13. The method of paragraph C12 wherein the polymeric amine surfactant is selected from the group of oligomeric surfactants comprising oleyl diethylene triamine, oleyl tetraethylene pentamine, dodecyl diethylene triamine, and dodecyl tetraethylene pentamine.

C14. The method of paragraph C12 wherein the polymeric amine surfactant is selected from the group of polymeric surfactants comprising polyisobutylene polyamine and polypropylene polyamine.

C15. The method of paragraph C12 wherein the polymeric amine surfactant has a molecular weight ranging from about 800 to about 3500.

C16. The method of paragraph C11 wherein the polymeric amine surfactant binds to hydrogen sulfide to form a polyamine-hydrogen sulfide complex when contacted by hydrogen sulfide.

C17. The method of paragraph C16 wherein the polyamine-hydrogen sulfide complex is adapted to capture water as a polyamine-hydrogen sulfide-water complex when contacted by water.

C18. The method of paragraph C1 wherein the non-surfactant amines are selected from the group comprising alkyl primary amines, alkyl secondary amines, and alkyl tertiary amines.

C19. The method of paragraph C18 wherein the non-surfactant amines are hindered.

C20. The method of paragraph C18 wherein the non-surfactant amine is a hydrogen sulfide scrubber.

C21. The method of paragraph C20 wherein the non-surfactant amine is tertiary butyl diethanol amine.

C22. The method of paragraph C1 wherein the guard bed composition is disposed in an annulus between two metal surfaces in a wellbore.

C23. The method of paragraph C1 wherein the guard bed composition is disposed in an annulus between an inner casing and an outer casing.

C24. The method of paragraph C23 wherein the inner casing is production casing and wherein the outer casing is selected from one or more of intermediate casing and surface casing.

C25. The method of paragraph C23, wherein the guard bed composition is adapted to protect a metal surface of at least one casing from fluids leaking into the annulus, wherein the one or more surfactants and the one or more co-surfactants are selected to at least substantially instantaneously micro-emulsify aqueous fluids in contact with the composition.

C26. The method of paragraph C25 wherein the aqueous fluid is a brine composition, and wherein brine compositions leaked into the annulus are micro-emulsified into droplets having a diameter less than about five microns in less than about five seconds.

C27. The method of paragraph C26 wherein the droplets are between about 10 nanometers and about 5 micrometers in diameter.

C28. The method of paragraph C27 wherein the droplets are between about 100 nanometers and about 1000 nanometers in diameter.

C29. The method of paragraph C26 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

C30. The method of paragraph C29 wherein the dissolved solids are selected from the group comprising salts of sodium, calcium, magnesium, potassium, lithium, and cesium.

C31. The method of paragraph C25 wherein greater than about 95% of the aqueous fluid is micro-emulsified in less than about 5 seconds.

C32. The method of paragraph C31 wherein greater than about 95% of the aqueous fluid is micro-emulsified in less than about 1 second.

C33. The method of paragraph C32 wherein greater than about 95% of the aqueous fluid is micro-emulsified in less than about 0.1 seconds.

C34. The method of paragraph C25 wherein the guard bed composition is adapted to micro-emulsify aqueous fluid up to an aqueous fluid:guard bed composition ratio of about 3:1.

D1. A guard bed composition for protecting a metal surface in a wellbore from corrosion, the composition comprising:
a hydrocarbon fluid; and
an overbased detergent; wherein the overbased detergent is selected to form a colloidal coating on the metal surface upon contact with hydrogen sulfide and water.

D2. The guard bed composition of paragraph D1 wherein the overbased detergent comprises greater than about 20 wt % based on the weight of the guard bed composition.

D3. The guard bed composition of paragraph D2 wherein the overbased detergent comprises between about 20 wt % and about 99 wt %.

D4. The guard bed composition of paragraph D1 further comprising at least one co-surfactant selected from the group comprising C3 to C15 alcohols, wherein the alcohols are selected from the group comprising branched alcohols, linear alcohols, and mixtures thereof.

D5. The guard bed composition of paragraph D1 wherein the hydrocarbon fluid comprises hydrocarbons selected from the group comprising normal and branched alkane hydrocarbons having C8 to C20 carbons, cyclic alkanes, synthetic oils, and mixtures thereof.

D6. The guard bed composition of paragraph D5 wherein the hydrocarbon fluid comprises an ultra low aromatic fluid.

D7. The guard bed composition of paragraph D6 wherein the hydrocarbon fluid comprises less than about 1 wt % aromatic compounds.

D8. The guard bed composition of paragraph D1 wherein the overbased detergent comprises compounds of the structure R-M_{N}, wherein N is greater than about 1.

D9. The guard bed composition of paragraph D8 wherein M is an inorganic compound.

D10. The guard bed composition of paragraph D9 wherein the inorganic compound is a metal base selected from the group comprising CaO, MgO, BaO, ZnO, CaCO3, MgCO3, BaCO3, and ZnCO3.

D11. The guard bed composition of paragraph D9 wherein R is a linear or branched surfactant selected to stabilize the metal base.

D12. The guard bed composition of paragraph D11 wherein R comprises surfactant having the structure S—Y, wherein S is a linear or branched C8 to C24 alkyl hydrocarbon group and Y is a polar group selected from the group comprising arylamines, phenates, salicylates, amines, and hydroxides.

D13. The guard bed composition of paragraph D1 wherein the overbased detergent is selected to at least substantially instantaneously micro-emulsify aqueous fluids in contact with the composition.

D14. The guard bed composition of paragraph D13 wherein the aqueous fluid is a brine composition, and wherein brine compositions introduced into the guard bed composition are micro-emulsified into droplets having a diameter less than about five microns in less than about five seconds.

D15. The guard bed composition of paragraph D14 wherein the droplets are between about 10 nanometers and about 5 micrometers in diameter.

D16. The guard bed composition of paragraph D15 wherein the droplets are between about 100 nanometers and about 1000 nanometers in diameter.

D17. The guard bed composition of paragraph D14 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

D18. The guard bed composition of paragraph D17 wherein the dissolved solids are selected from the group comprising salts of sodium, calcium, magnesium, potassium, lithium, and cesium.

D19. The guard bed composition of paragraph D13 wherein greater than about 95% of the aqueous fluid is micro-emulsified in less than about 5 seconds.

D20. The guard bed composition of paragraph D19 wherein greater than about 95% of the aqueous fluid is micro-emulsified in less than about 1 second.

D21. The guard bed composition of paragraph D20 wherein greater than about 95% of the aqueous fluid is micro-emulsified in less than about 0.1 seconds.

D22. The guard bed composition of paragraph D1 wherein the guard bed composition is adapted to micro-emulsify aqueous fluid up to an aqueous fluid:guard bed composition ratio of about 3:1.

D23. The guard bed composition of paragraph D1 wherein the guard bed composition is adapted to scrub hydrogen sulfide.

E1. A method of preparing a guard bed composition adapted for the protection of a metal surface in a wellbore from corrosion, the method comprising:
obtaining a hydrocarbon fluid;
obtaining an overbased detergent; wherein the overbased detergent is selected to form a colloidal coating on the metal surface upon contact with hydrogen sulfide and water; and
mixing the hydrocarbon fluid and the overbased detergent.

E2. The method of paragraph E1 wherein the overbased detergent comprises greater than about 20 wt % based on the weight of the guard bed composition.

E3. The method of paragraph E2 wherein the overbased detergent comprises between about 20 wt % and about 99 wt %.

E4. The method of paragraph E1 further comprising:
obtaining at least one co-surfactant selected from the group comprising C3 to C15 alcohols, wherein the alcohols are selected from the group comprising branched alcohols, linear alcohols, and mixtures thereof; and
mixing the at least one co-surfactant.

E5. The method of paragraph E1 wherein the hydrocarbon fluid comprises hydrocarbons selected from the group comprising normal and branched alkane hydrocarbons having C8 to C20 carbons, cyclic alkanes, synthetic oils, and mixtures thereof.

E6. The method of paragraph E5 wherein the hydrocarbon fluid comprises an ultra low aromatic fluid.

E7. The method of paragraph E6 wherein the hydrocarbon fluid comprises less than about 1 wt % aromatic compounds.

E8. The method of paragraph E1 wherein the overbased detergent comprises compounds of the structure R-M_{N}, wherein N is greater than about 1.

E9. The method of paragraph E8 wherein M is an inorganic compound.

E10. The method of paragraph E9 wherein the inorganic compound is a metal base selected from the group comprising CaO, MgO, BaO, ZnO, CaCO3, MgCO3, BaCO3, and ZnCO3.

E11. The method of paragraph E9 wherein R is a linear or branched surfactant selected to stabilize the metal base.

E12. The method of paragraph E11 wherein R comprises surfactant having the structure S—Y, wherein S is a linear or branched C8 to C24 alkyl hydrocarbon group and Y is a polar group selected from the group comprising arylamines, phenates, salicylates, amines, and hydroxides.

E13. The method of paragraph E1 wherein the overbased detergent is selected to at least substantially instantaneously micro-emulsify aqueous fluids in contact with the composition.

E14. The method of paragraph E13 wherein the aqueous fluid is a brine composition, and wherein brine compositions introduced into the guard bed composition are micro-emulsified into droplets having a diameter less than about five microns in less than about five seconds.

E15. The method of paragraph E14 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

E16. The method of paragraph E15 wherein the dissolved solids are selected from the group comprising salts of sodium, calcium, magnesium, potassium, lithium, and cesium.

E17. The method of paragraph E1 wherein the guard bed composition is adapted to micro-emulsify aqueous fluid up to an aqueous fluid:guard bed composition ratio of about 3:1.

E18. The method of paragraph E1 wherein the guard bed composition is adapted to scrub hydrogen sulfide.

F1. A method of protecting a metal surface in a wellbore from corrosion, the method comprising:
obtaining a guard bed composition comprising:
   a hydrocarbon fluid; and
   an overbased detergent; wherein the overbased detergent is selected to form a colloidal coating on the metal surface upon contact with hydrogen sulfide and water;
disposing the guard bed composition adjacent to a metal surface in a wellbore; and
producing hydrocarbons through the wellbore.

F2. The method of paragraph F1 wherein the overbased detergent comprises greater than about 20 wt % based on the weight of the guard bed composition.

F3. The method of paragraph F2 wherein the overbased detergent comprises between about 20 wt % and about 99 wt %.

F4. The method of paragraph F1 further comprising:
obtaining at least one co-surfactant selected from the group comprising C3 to C15 alcohols, wherein the alcohols are selected from the group comprising branched alcohols, linear alcohols, and mixtures thereof; and
mixing the at least one co-surfactant.

F5. The method of paragraph F1 wherein the hydrocarbon fluid comprises hydrocarbons selected from the group comprising normal and branched alkane hydrocarbons having C8 to C20 carbons, cyclic alkanes, synthetic oils, and mixtures thereof.

F6. The method of paragraph F5 wherein the hydrocarbon fluid comprises an ultra low aromatic fluid.

F7. The method of paragraph F6 wherein the hydrocarbon fluid comprises less than about 1 wt % aromatic compounds.

F8. The method of paragraph F1 wherein the overbased detergent comprises compounds of the structure R-M_{N}, wherein N is greater than about 1.

F9. The method of paragraph F8 wherein M is an inorganic compound.

F10. The method of paragraph F9 wherein the inorganic compound is a metal base selected from the group comprising CaO, MgO, BaO, ZnO, CaCO3, MgCO3, BaCO3, and ZnCO3.

F11. The method of paragraph F9 wherein R is a linear or branched surfactant selected to stabilize the metal base.

F12. The method of paragraph F11 wherein R comprises surfactant having the structure S—Y, wherein S is a linear or branched C8 to C24 alkyl hydrocarbon group and Y is a polar group selected from the group comprising arylamines, phenates, salicylates, amines, and hydroxides.

F13. The method of paragraph F1 wherein the guard bed composition is disposed in an annulus between two metal surfaces in a wellbore.

F14. The method of paragraph F1 wherein the guard bed composition is disposed in an annulus between an inner casing and an outer casing.

F15. The method of paragraph F14 wherein the inner casing is production casing and wherein the outer casing is selected from one or more of intermediate casing and surface casing.

F16. The method of paragraph F14, wherein the guard bed composition is adapted to protect a metal surface of at least one casing from fluids leaking into the annulus, wherein the overbased detergent is selected to at least substantially instantaneously micro-emulsify aqueous fluids in contact with the composition.

F17. The method of paragraph F16 wherein the aqueous fluid is a brine composition, and wherein brine compositions introduced into the guard bed composition are micro-emulsified into droplets having a diameter less than about five microns in less than about five seconds.

F18. The method of paragraph F17 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

F19. The method of paragraph F18 wherein the dissolved solids are selected from the group comprising salts of sodium, calcium, magnesium, potassium, lithium, and cesium.

F20. The method of paragraph F1 wherein the guard bed composition is adapted to micro-emulsify aqueous fluid up to an aqueous fluid:guard bed composition ratio of about 3:1.

F21. The method of paragraph F1 wherein the guard bed composition is adapted to scrub hydrogen sulfide.

G1. A guard bed composition for protecting a metal surface in a wellbore from corrosion, the composition comprising:
a hydrocarbon fluid;
one or more surfactants selected from the group comprising alkyl alkoxylated surfactants;
one or more co-surfactants selected from the group comprising C3 to C15 alcohols; and
one or more non-surfactant amines.

G2. The guard bed composition of paragraph G1 wherein the hydrocarbon fluid comprises between about 0 wt % and about 90 wt % based on the weight of the guard bed composition.

G3. The guard bed composition of paragraph G1 wherein the hydrocarbon fluid comprises hydrocarbons selected from the group of normal and branched alkane hydrocarbons having C8 to C20 carbons.

G4. The guard bed composition of paragraph G1 wherein the hydrocarbon fluid comprises cyclic hydrocarbons.

G5. The guard bed composition of paragraph G1 wherein the hydrocarbon fluid comprises an ultra low aromatic fluid.

G6. The guard bed composition of paragraph G5 wherein the hydrocarbon fluid comprises less than about 1 wt % aromatic compounds.

G7. The guard bed composition of paragraph G1 wherein the alkyl alkoxylated surfactants comprise at least one alkyl alkoxylated surfactant selected from the group comprising alkyl and alkyl aromatic alkoxylated surfactants.

G8. The guard bed composition of paragraph G7 wherein the alkoxylate group is selected from the group comprising ethylene oxide, propylene oxide, butylene oxide and mixtures thereof.

G9. The guard bed composition of paragraph G1 wherein the alkyl alkoxylated surfactants comprise at least one surfactant selected from the group comprising alkyl sorbitan alkoxylates, alkyl alcohol ethoxylates, alkyl acid ethoxylates and alkyl nonylphenol ethoxylates.

G10. The guard bed composition of paragraph G1 wherein the non-surfactant amines are selected from the group comprising alkyl primary amines, alkyl secondary amines, and alkyl tertiary amines.

G11. The guard bed composition of paragraph G10 wherein the non-surfactant amines are hindered.

G12. The guard bed composition of paragraph G10 wherein the non-surfactant amine is a hydrogen sulfide scrubber.

G13. The guard bed composition of paragraph G10 wherein the non-surfactant amine is tertiary butyl diethanol amine.

G14. The guard bed composition of paragraph G1 wherein the one or more surfactants and the one or more co-surfactants are selected to form an oil continuous surfactant liquid crystalline mesophase upon interaction of the guard bed composition with aqueous fluids.

G15. The guard bed composition of paragraph G14 wherein the aqueous fluid is a brine composition, and wherein brine compositions introduced into the guard bed composition are micro-emulsified into droplets having a diameter less than about five microns in less than about five seconds.

G16. The guard bed composition of paragraph G15 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

G17. The guard bed composition of paragraph G16 wherein the dissolved solids are selected from the group comprising salts of sodium, calcium, magnesium, potassium, lithium, and cesium.

G18. The guard bed composition of paragraph G14 wherein the guard bed composition is adapted to micro-emulsify aqueous fluid up to an aqueous fluid:guard bed composition ratio of about 3:1.

G19. The guard bed composition of paragraph G14 wherein the aqueous fluid comprises hydrogen sulfide, and wherein the non-surfactant amines are selected to scrub the hydrogen sulfide.

H1. A method of preparing a guard bed composition adapted for the protection of a metal surface in a wellbore from corrosion, the method comprising:
obtaining a hydrocarbon fluid;
obtaining one or more surfactants selected from the group comprising alkyl alkoxylated surfactants;
obtaining one or more co-surfactants selected from the group comprising C3 to C15 alcohols;
obtaining one or more non-surfactant amines; and
mixing the surfactants, the co-surfactants, and the non-surfactant amines in the hydrocarbon fluid.

H2. The method of paragraph H1 wherein the hydrocarbon fluid comprises between about 0 wt % and about 90 wt % based on the weight of the guard bed composition.

H3. The method of paragraph H1 wherein the hydrocarbon fluid comprises hydrocarbons selected from the group of normal and branched alkane hydrocarbons having C8 to C20 carbons.

H4. The method of paragraph H3 wherein the hydrocarbon fluid comprises an ultra low aromatic fluid.

H5. The method of paragraph H1 wherein the alkyl alkoxylated surfactants comprise at least one alkyl alkoxylated surfactant selected from the group comprising alkyl and alkyl aromatic alkoxylated surfactants.

H6. The method of paragraph H5 wherein the alkoxylate group is selected from the group comprising ethylene oxide, propylene oxide, butylene oxide and mixtures thereof.

H7. The method of paragraph H1 wherein the alkyl alkoxylated surfactants comprise at least one surfactant selected from the group comprising alkyl sorbitan alkoxylates, alkyl alcohol ethoxylates, alkyl acid ethoxylates and alkyl nonylphenol ethoxylates.

H8. The method of paragraph H1 wherein the non-surfactant amines are selected from the group comprising alkyl primary amines, alkyl secondary amines, and alkyl tertiary amines.

H9. The method of paragraph H8 wherein the non-surfactant amines are hindered.

H10. The method of paragraph H8 wherein the non-surfactant amine is a hydrogen sulfide scrubber.

H11. The method of paragraph H10 wherein the non-surfactant amine is tertiary butyl diethanol amine.

H12. The method of paragraph H1 wherein the one or more surfactants and the one or more co-surfactants are selected to form an oil continuous surfactant liquid crystalline mesophase upon interaction of the guard bed composition with aqueous fluids.

H13. The method of paragraph H12 wherein the guard bed composition is adapted to micro-emulsify aqueous fluid up to an aqueous fluid:guard bed composition ratio of about 3:1.

H14. The method of paragraph H12 wherein the aqueous fluid is a brine composition, and wherein brine compositions introduced into the guard bed composition are micro-emulsified into droplets having a diameter less than about five microns in less than about five seconds.

H15. The method of paragraph H14 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

H16. The method of paragraph H15 wherein the dissolved solids are selected from the group comprising salts of sodium, calcium, magnesium, potassium, lithium, and cesium.

H17. The method of paragraph H14 wherein the aqueous fluid comprises hydrogen sulfide, and wherein the non-surfactant amines are selected to scrub the hydrogen sulfide.

J1. A method of protecting a metal surface in a wellbore from corrosion, the method comprising:
obtaining a guard bed composition comprising:
   a hydrocarbon fluid;
   one or more surfactants selected from the group comprising alkyl alkoxylated surfactants;
   one or more co-surfactants selected from the group comprising C3 to C15 alcohols; and
   one or more non-surfactant amines;
disposing the guard bed composition adjacent to a metal surface in a wellbore; and
producing hydrocarbons through the wellbore.

J2. The method of paragraph J1 wherein the hydrocarbon fluid comprises between about 0 wt % and about 90 wt % based on the weight of the guard bed composition.

J3. The method of paragraph J1 wherein the hydrocarbon fluid comprises hydrocarbons selected from the group of normal and branched alkane hydrocarbons having C8 to C20 carbons.

J4. The method of paragraph J3 wherein the hydrocarbon fluid comprises an ultra low aromatic fluid.

J5. The method of paragraph J1 wherein the alkyl alkoxylated surfactants comprise at least one alkyl alkoxylated surfactant selected from the group comprising alkyl and alkyl aromatic alkoxylated surfactants.

J6. The method of paragraph J5 wherein the alkoxylate group is selected from the group comprising ethylene oxide, propylene oxide, butylene oxide and mixtures thereof.

J7. The method of paragraph J1 wherein the alkyl alkoxylated surfactants comprise at least one surfactant selected from the group comprising alkyl sorbitan alkoxylates, alkyl alcohol ethoxylates, alkyl acid ethoxylates and alkyl nonylphenol ethoxylates.

J8. The method of paragraph J1 wherein the non-surfactant amines are selected from the group comprising alkyl primary amines, alkyl secondary amines, and alkyl tertiary amines.

J9. The method of paragraph J8 wherein the non-surfactant amines are hindered.

J10. The method of paragraph J8 wherein the non-surfactant amine is a hydrogen sulfide scrubber.

J11. The method of paragraph J10 wherein the non-surfactant amine is tertiary butyl diethanol amine.

J12. The method of paragraph J1 wherein the one or more surfactants and the one or more co-surfactants are selected to form an oil continuous surfactant liquid crystalline mesophase upon interaction of the guard bed composition with aqueous fluids.

J13. The method of paragraph J12 wherein the guard bed composition is adapted to micro-emulsify aqueous fluid up to an aqueous fluid:guard bed composition ratio of about 3:1.

J14. The method of paragraph J12 wherein the aqueous fluid is a brine composition, and wherein brine compositions introduced into the guard bed composition are micro-emulsified into droplets having a diameter less than about five microns in less than about five seconds.

J15. The method of paragraph J14 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

J16. The method of paragraph J15 wherein the dissolved solids are selected from the group comprising salts of sodium, calcium, magnesium, potassium, lithium, and cesium.

J17. The method of paragraph J14 wherein the aqueous fluid comprises hydrogen sulfide, and wherein the non-surfactant amines are selected to scrub the hydrogen sulfide.

J18. The method of paragraph J1 wherein the guard bed composition is disposed in an annulus between two metal surfaces in a wellbore.

J19. The method of paragraph J1 wherein the guard bed composition is disposed in an annulus between an inner casing and an outer casing.

J20. The method of paragraph J19 wherein the inner casing is production casing and wherein the outer casing is selected from one or more of intermediate casing and surface casing.

J21. The method of paragraph J19, wherein the guard bed composition is adapted to protect a metal surface of at least one casing from fluids leaking into the annulus, wherein the one or more surfactants and the one or more co-surfactants are selected to at least substantially instantaneously micro-emulsify aqueous fluids in contact with the composition.

K1. A guard bed composition for protecting a metal surface in a wellbore from corrosion, the composition comprising:
a hydrocarbon fluid; and
one or more associating surface active polymers selected from the group comprising amphiphilic polymers.

K2. The guard bed composition of paragraph K1 wherein the polymer comprises between about 0.1 wt % and about 10 wt % of the guard bed composition.

K3. The guard bed composition of paragraph K1 wherein the hydrocarbon fluid comprises hydrocarbons selected from the group of normal and branched alkane hydrocarbons having C8 to C20 carbons.

K4. The guard bed composition of paragraph K1 wherein the hydrocarbon fluid comprises cyclic hydrocarbons.

K5. The guard bed composition of paragraph K1 wherein the hydrocarbon fluid comprises synthetic oils.

K6. The guard bed composition of paragraph K1 wherein the hydrocarbon fluid comprises an ultra low aromatic fluid.

K7. The guard bed composition of paragraph K6 wherein the hydrocarbon fluid comprises less than about 1 wt % aromatic compounds.

K8. The guard bed composition of paragraph K1 wherein the associating surface active polymers comprise a hydrocarbon backbone with pendant polar groups.

K9. The guard bed composition of paragraph K8 wherein the associating surface active polymers are selected from the group comprising poly acrylic acid, partially hydrolyzed poly acryl amide, poly ethylene glycol, and mixtures thereof.

K10. The guard bed composition of paragraph K1 wherein the composition further comprises surfactants selected from the group comprising alkyl sorbitans and alkyl sorbitan alkoxylated surfactants.

K11. The guard bed composition of paragraph K10 wherein the surfactant comprises a surfactant from the group comprising alkyl sorbitan ethoxylates.

K12. The guard bed composition of paragraph K10 wherein the composition further comprises co-surfactants selected from the group comprising C3 to C15 linear and branched alcohols.

K13. The guard bed composition of paragraph K1 wherein interaction between the composition and leaked aqueous fluids substantially immediately encapsulates substantially all of the aqueous fluids in micro-domains formed by the associating surface active polymers.

K14. The guard bed composition of paragraph K13 wherein the formation of micro-domains forms a gel-like structure.

K15. The guard bed composition of paragraph K13 wherein the aqueous fluid is a brine composition, and wherein brine compositions introduced into the guard bed composition are encapsulated into micro-domains having a diameter less than about five microns in less than about five seconds.

K16. The guard bed composition of paragraph K15 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

K17. The guard bed composition of paragraph K16 wherein the dissolved solids are selected from the group comprising salts of sodium, calcium, magnesium, potassium, lithium, and cesium.

K18. The guard bed composition of paragraph K13 wherein the guard bed composition is adapted to encapsulate aqueous fluid up to an aqueous fluid:guard bed composition ratio of about 3:1.

K19. The guard bed composition of paragraph K13 wherein the aqueous fluid comprises hydrogen sulfide.

L1. A method of preparing a guard bed composition adapted for the protection of a metal surface in a wellbore from corrosion, the method comprising:
obtaining a hydrocarbon fluid;
obtaining one or more associating surface active polymers selected from the group comprising amphiphilic polymers; and
mixing the surface active polymers in the hydrocarbon fluid.

L2. The method of paragraph L1 wherein the surface active polymer comprises between about 0.1 wt % and about 10 wt % of the guard bed composition.

L3. The method of paragraph L1 wherein the hydrocarbon fluid comprises hydrocarbons selected from the group of normal and branched alkane hydrocarbons having C8 to C20 carbons.

L4. The method of paragraph L3 wherein the hydrocarbon fluid comprises an ultra low aromatic fluid.

L5. The method of paragraph L1 wherein the associating surface active polymers comprise a hydrocarbon backbone with pendant polar groups.

L6. The method of paragraph L5 wherein the associating surface active polymers are selected from the group comprising poly acrylic acid, partially hydrolyzed poly acryl amide, poly ethylene glycol, and mixtures thereof.

L7. The method of paragraph L1 wherein the composition further comprises surfactants selected from the group comprising alkyl sorbitans and alkyl sorbitan alkoxylated surfactants.

L8. The method of paragraph L7 wherein the surfactant comprises a surfactant from the group comprising alkyl sorbitan ethoxylates.

L9. The method of paragraph L7 wherein the composition further comprises co-surfactants selected from the group comprising C3 to C15 linear and branched alcohols.

L10. The method of paragraph L1 wherein interaction between the composition and leaked aqueous fluids substantially immediately encapsulates substantially all of the aqueous fluids in micro-domains formed by the associating surface active polymers.

L11. The method of paragraph L10 wherein the formation of micro-domains forms a gel-like structure.

L12. The method of paragraph L10 wherein the aqueous fluid is a brine composition, and wherein brine compositions introduced into the guard bed composition are encapsulated into micro-domains having a diameter less than about five microns in less than about five seconds.

L13. The method of paragraph L12 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

L14. The method of paragraph L13 wherein the dissolved solids are selected from the group comprising salts of sodium, calcium, magnesium, potassium, lithium, and cesium.

L15. The method of paragraph L10 wherein the guard bed composition is adapted to encapsulate aqueous fluid up to an aqueous fluid:guard bed composition ratio of about 3:1.

L16. The method of paragraph L10 wherein the aqueous fluid comprises hydrogen sulfide.

M1. A method of protecting a metal surface in a wellbore from corrosion, the method comprising:
obtaining a guard bed composition comprising:
   a hydrocarbon fluid; and
   one or more associating surface active polymers selected from the group comprising amphiphilic polymers.
disposing the guard bed composition adjacent to a metal surface in a wellbore; and
producing hydrocarbons through the wellbore.

M2. The method of paragraph M1 wherein the polymer comprises between about 0.1 wt % and about 10 wt % of the guard bed composition.

M3. The method of paragraph M1 wherein the hydrocarbon fluid comprises hydrocarbons selected from the group of normal and branched alkane hydrocarbons having C8 to C20 carbons.

M4. The method of paragraph M3 wherein the hydrocarbon fluid comprises an ultra low aromatic fluid.

M5. The method of paragraph M1 wherein the associating surface active polymers comprise a hydrocarbon backbone with pendant polar groups.

M6. The method of paragraph M5 wherein the associating surface active polymers are selected from the group comprising poly acrylic acid, partially hydrolyzed poly acryl amide, poly ethylene glycol, and mixtures thereof.

M7. The method of paragraph M1 wherein the composition further comprises surfactants selected from the group comprising alkyl sorbitans and alkyl sorbitan alkoxylated surfactants.

M8. The method of paragraph M7 wherein the surfactant comprises a surfactant from the group comprising alkyl sorbitan ethoxylates.

M9. The method of paragraph M7 wherein the composition further comprises co-surfactants selected from the group comprising C3 to C15 linear and branched alcohols.

M10. The method of paragraph M1 wherein interaction between the composition and leaked aqueous fluids substantially immediately encapsulates substantially all of the aqueous fluids in micro-domains formed by the associating surface active polymers.

M11. The method of paragraph M10 wherein the formation of micro-domains forms a gel-like structure.

M12. The method of paragraph M10 wherein the aqueous fluid is a brine composition, and wherein brine compositions introduced into the guard bed composition are encapsulated into micro-domains having a diameter less than about five microns in less than about five seconds.

M13. The method of paragraph M12 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

M14. The method of paragraph M13 wherein the dissolved solids are selected from the group comprising salts of sodium, calcium, magnesium, potassium, lithium, and cesium.

M15. The method of paragraph M10 wherein the guard bed composition is adapted to encapsulate aqueous fluid up to an aqueous fluid:guard bed composition ratio of about 3:1.

M16. The method of paragraph M1 wherein the guard bed composition is disposed in an annulus between two metal surfaces in a wellbore.

M17. The method of paragraph M1 wherein the guard bed composition is disposed in an annulus between an inner casing and an outer casing.

M18. The method of paragraph M17 wherein the inner casing is production casing and wherein the outer casing is selected from one or more of intermediate casing and surface casing.

M19. The method of paragraph M17, wherein the guard bed composition is adapted to protect a metal surface of at least one casing from fluids leaking into the annulus, wherein the one or more surfactants and the one or more co-surfactants are selected to at least substantially instantaneously micro-emulsify aqueous fluids in contact with the composition.

### INDUSTRIAL APPLICABILITY

The systems and methods described herein are applicable to the oil and gas industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

What is claimed is:

1. A guard bed composition for protecting a metal surface in a wellbore from corrosion, the composition comprising:
a hydrocarbon fluid;
one or more surfactants selected from the group comprising alkyl alkoxylated surfactants;
one or more co-surfactants selected from the group comprising C3 to C15 alcohols; and
one or more non-surfactant amines.

2. The guard bed composition of claim 1 wherein the hydrocarbon fluid comprises between about 0 wt % and about 90 wt % based on the weight of the guard bed composition.

3. The guard bed composition of claim 1 wherein the hydrocarbon fluid comprises hydrocarbons selected from the group of normal and branched alkane hydrocarbons having C8 to C20 carbons.

4. The guard bed composition of claim 1 wherein the hydrocarbon fluid comprises cyclic hydrocarbons.

5. The guard bed composition of claim 1 wherein the hydrocarbon fluid comprises an ultra low aromatic fluid.

6. The guard bed composition of claim 5 wherein the hydrocarbon fluid comprises less than about 1 wt % aromatic compounds.

7. The guard bed composition of claim 1 wherein the alkyl alkoxylated surfactants comprise at least one alkyl alkoxylated surfactant selected from the group comprising alkyl and alkyl aromatic alkoxylated surfactants.

8. The guard bed composition of claim 7 wherein the alkoxylate group is selected from the group comprising ethylene oxide, propylene oxide, butylene oxide and mixtures thereof.

9. The guard bed composition of claim 1 wherein the alkyl alkoxylated surfactants comprise at least one surfactant selected from the group comprising alkyl sorbitan alkoxylates, alkyl alcohol ethoxylates, alkyl acid ethoxylates and alkyl nonylphenol ethoxylates.

10. The guard bed composition of claim 1 wherein the non-surfactant amines are selected from the group comprising alkyl primary amines, alkyl secondary amines, and alkyl tertiary amines.

11. The guard bed composition of claim 10 wherein the non-surfactant amines are hindered.

12. The guard bed composition of claim 10 wherein the non-surfactant amine is a hydrogen sulfide scrubber.

13. The guard bed composition of claim 10 wherein the non-surfactant amine is tertiary butyl diethanol amine.

14. The guard bed composition of claim 1 wherein the one or more surfactants and the one or more co-surfactants are selected to form an oil continuous surfactant liquid crystalline mesophase upon interaction of the guard bed composition with aqueous fluids.

15. The guard bed composition of claim 14 wherein the aqueous fluid is a brine composition, and wherein brine compositions introduced into the guard bed composition are micro-emulsified into droplets having a diameter less than about five microns in less than about five seconds.

16. The guard bed composition of claim 15 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

17. The guard bed composition of claim 16 wherein the dissolved solids are selected from the group comprising salts of sodium, calcium, magnesium, potassium, lithium, and cesium.

18. The guard bed composition of claim 14 wherein the guard bed composition is adapted to micro-emulsify aqueous fluid up to an aqueous fluid:guard bed composition ratio of about 3:1.

19. The guard bed composition of claim 14 wherein the aqueous fluid comprises hydrogen sulfide, and wherein the non-surfactant amines are selected to scrub the hydrogen sulfide.

20. A method of preparing a guard bed composition adapted for the protection of a metal surface in a wellbore from corrosion, the method comprising:
obtaining a hydrocarbon fluid;
obtaining one or more surfactants selected from the group comprising alkyl alkoxylated surfactants;
obtaining one or more co-surfactants selected from the group comprising C3 to C15 alcohols;
obtaining one or more non-surfactant amines; and
mixing the surfactants, the co-surfactants, and the non-surfactant amines in the hydrocarbon fluid.

21. The method of claim 20 wherein the hydrocarbon fluid comprises between about 0 wt % and about 90 wt % based on the weight of the guard bed composition.

22. The method of claim 20 wherein the hydrocarbon fluid comprises hydrocarbons selected from the group of normal and branched alkane hydrocarbons having C8 to C20 carbons.

23. The method of claim 22 wherein the hydrocarbon fluid comprises an ultra low aromatic fluid.

24. The method of claim 20 wherein the alkyl alkoxylated surfactants comprise at least one alkyl alkoxylated surfactant selected from the group comprising alkyl and alkyl aromatic alkoxylated surfactants.

25. The method of claim 24 wherein the alkoxylate group is selected from the group comprising ethylene oxide, propylene oxide, butylene oxide and mixtures thereof.

26. The method of claim 20 wherein the alkyl alkoxylated surfactants comprise at least one surfactant selected from the group comprising alkyl sorbitan alkoxylates, alkyl alcohol ethoxylates, alkyl acid ethoxylates and alkyl nonylphenol ethoxylates.

27. The method of claim 20 wherein the non-surfactant amines are selected from the group comprising alkyl primary amines, alkyl secondary amines, and alkyl tertiary amines.

28. The method of claim 27 wherein the non-surfactant amines are hindered.

29. The method of claim 27 wherein the non-surfactant amine is a hydrogen sulfide scrubber.

30. The method of claim 29 wherein the non-surfactant amine is tertiary butyl diethanol amine.

31. The method of claim 20 wherein the one or more surfactants and the one or more co-surfactants are selected to form an oil continuous surfactant liquid crystalline mesophase upon interaction of the guard bed composition with aqueous fluids.

32. The method of claim 31 wherein the guard bed composition is adapted to micro-emulsify aqueous fluid up to an aqueous fluid:guard bed composition ratio of about 3:1.

33. The method of claim 31 wherein the aqueous fluid is a brine composition, and wherein brine compositions introduced into the guard bed composition are micro-emulsified into droplets having a diameter less than about five microns in less than about five seconds.

34. The method of claim 33 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

35. The method of claim 34 wherein the dissolved solids are selected from the group comprising salts of sodium, calcium, magnesium, potassium, lithium, and cesium.

36. The method of claim 33 wherein the aqueous fluid comprises hydrogen sulfide, and wherein the non-surfactant amines are selected to scrub the hydrogen sulfide.

37. A method of protecting a metal surface in a wellbore from corrosion, the method comprising:
obtaining a guard bed composition comprising:
a hydrocarbon fluid;
one or more surfactants selected from the group comprising alkyl alkoxylated surfactants;
one or more co-surfactants selected from the group comprising C3 to C15 alcohols; and
one or more non-surfactant amines;
disposing the guard bed composition adjacent to a metal surface in a wellbore; and
producing hydrocarbons through the wellbore.

38. The method of claim 37 wherein the hydrocarbon fluid comprises between about 0 wt % and about 90 wt % based on the weight of the guard bed composition.

39. The method of claim 37 wherein the hydrocarbon fluid comprises hydrocarbons selected from the group of normal and branched alkane hydrocarbons having C8 to C20 carbons.

40. The method of claim 39 wherein the hydrocarbon fluid comprises an ultra low aromatic fluid.

41. The method of claim 37 wherein the alkyl alkoxylated surfactants comprise at least one alkyl alkoxylated surfactant selected from the group comprising alkyl and alkyl aromatic alkoxylated surfactants.

42. The method of claim 41 wherein the alkoxylate group is selected from the group comprising ethylene oxide, propylene oxide, butylene oxide and mixtures thereof.

43. The method of claim 37 wherein the alkyl alkoxylated surfactants comprise at least one surfactant selected from the group comprising alkyl sorbitan alkoxylates, alkyl alcohol ethoxylates, alkyl acid ethoxylates and alkyl nonylphenol ethoxylates.

44. The method of claim 37 wherein the non-surfactant amines are selected from the group comprising alkyl primary amines, alkyl secondary amines, and alkyl tertiary amines.

45. The method of claim 44 wherein the non-surfactant amines are hindered.

46. The method of claim 44 wherein the non-surfactant amine is a hydrogen sulfide scrubber.

47. The method of claim 46 wherein the non-surfactant amine is tertiary butyl diethanol amine.

48. The method of claim 37 wherein the one or more surfactants and the one or more co-surfactants are selected to form an oil continuous surfactant liquid crystalline mesophase upon interaction of the guard bed composition with aqueous fluids.

49. The method of claim 48 wherein the guard bed composition is adapted to micro-emulsify aqueous fluid up to an aqueous fluid:guard bed composition ratio of about 3:1.

50. The method of claim 48 wherein the aqueous fluid is a brine composition, and wherein brine compositions introduced into the guard bed composition are micro-emulsified into droplets having a diameter less than about five microns in less than about five seconds.

51. The method of claim 50 wherein the brine composition is between about 0.01 wt % and about 30 wt % dissolved solids based on the weight of the brine composition, wherein the dissolved solids are selected from the group comprising chloride salts, carbonate salts, bicarbonate salts, and sulfate salts.

52. The method of claim 51 wherein the dissolved solids are selected from the group comprising salts of sodium, calcium, magnesium, potassium, lithium, and cesium.

53. The method of claim 50 wherein the aqueous fluid comprises hydrogen sulfide, and wherein the non-surfactant amines are selected to scrub the hydrogen sulfide.

54. The method of claim 37 wherein the guard bed composition is disposed in an annulus between two metal surfaces in a wellbore.

55. The method of claim 37 wherein the guard bed composition is disposed in an annulus between an inner casing and an outer casing.

56. The method of claim 55 wherein the inner casing is production casing and wherein the outer casing is selected from one or more of intermediate casing and surface casing.

57. The method of claim 55, wherein the guard bed composition is adapted to protect a metal surface of at least one casing from fluids leaking into the annulus, wherein the one or more surfactants and the one or more co-surfactants are selected to at least substantially instantaneously micro-emulsify aqueous fluids in contact with the composition.
